(19) United States
(12) Patent Application Publication
(10) Pub. No.: US 2012/0023682 A1
(43) Pub. Date: Feb. 2, 2012

(54) Natural alternative to wax to remove unwanted hair

(75) Inventor: Anwar Radha, Endicott, NY (US)

(73) Assignee: Anwar Radha, Endicott, NY (US)

(21) Appl. No.: 12/803,871

(22) Filed: Aug. 2, 2010

(51) Int. Cl. C14C 1/06; A61Q 9/04

(52) U.S. Cl. 8/161

(57) ABSTRACT

The natural alternative to wax to remove unwanted hair does not cause irritation to any type of skin. It is made of sugar, water and lemon. It does not need a special machine to heat it, and does not take time to reach the right temperature to be ready for use. It is environmental friendly because it does not need disposal wooden sticks to apply it, and does not need disposal sheets to remove unwanted hair. It also does not need lotions after removing the unwanted hair because it does not dry the skin and keeps it smooth. It is also affordable that is enough to apply on full body many times. The hair does not grow after the application of the natural alternative at least for three to six weeks.

The inspiration:

I was visiting my barber to have a hair-cut, and she was shaping another client's eyebrows with wax while I was waiting. I said: “Waxing itches me.” The barber said: “how do you do your eyebrows then?” I said: “I tweeze them.” She said: “No, that takes a long time.” I said: “not really, it is just fifteen minutes.” She said: “No, waxing is faster.” I said: “But it causes irritation.” She said: “That is normal. After ten hours, you will be fine.” TEN HOURS?!!! She is not ok to tweeze for fifteen minutes, but ok to itch for ten hours! I had to come up with something that is faster than tweezing and not itching as waxing. Here comes the invention:

### The Items:

Any kind of sugar (preferably organic since this invention is all natural).

Water (tab water is ok).

Fresh lemon (do not use the packed lemon juice whether there is sugar added to it or not).

A medium steel pot. This pot should be only dedicated to this recipe, and not other cooking food since there will be plenty left-over of the Natural Alternative, and it may contain hair; the same thing should be followed with all items including the steel bowl and cream cake spreaders.

Two sizes (small and large) of cream cake metal spreaders. The small is to spread the Natural Alternative on the small areas of the body, and the large one is one the large areas and to prepare the Natural Alternative as well.

A small steel bowl filled with hot water.

“Natural Muslin Epilating Strips” from Sally Stores or a thicker virgin of it—as I bought from fabric store. They are thick enough to be applied and removed without being damaged to be reused all the time. Any other strips from Sally Stores MAY or MAY NOT work the same way.

The Ingredients:

5 mugs of sugar

2 mugs of water

a quarter mug of lemon juice

* Note: any size of mug works as long as the same size of mug is used to measure all the ingredients. These ingredients may be used before in other products but in different measures, and this is why they are very solid and hard to work with, or too sticky that is hard to remove.

### The Recipe:

1 Melt two mugs of sugar in the steel pot on medium to low heat (number 2 of the controllers of the stove).

2 Let the completely melted sugar to rest away from the stove for 10 minutes.

3 Add slowly the two mugs of water.

4 Put the mix on the stove again on the same level of heat, and then add the other three mugs of sugar altogether until everything melts.

5 Check out the consistency (not dripping) with the large cream cake metal spreader.

6 Let it cool a little bit for 2 minutes. It is supposed to be hot like wax, but not too hot, to spread easily.

### The Application of Natural Alternative:

1 A thin layer of the Natural Alternative should be applied on the unwanted hair directly by the cream cake spreader. Cover as much as the size of your two hands at a time—if removing hair from legs, and with small areas like eyebrows apply as little as the area you want to remove hair from.

2 Stick the fabric strip over and remove as the way with waxing.

3 After many applications, and the fabric strip is completely covered with the hair and the Natural Alternative, the fabric strip is dipped into the small steel bowl filled with hot water to dissolve everything. After an hour, all fabric strips in the bowl will be ready for wash with soap (by hand if they are “Natural Muslin Epilating Strips” from Sally Stores, but if they are the thicker virgin from the fabric store, they can be washed in the washing machine for reuse again and again). Get rid of the dirty water and wash the bowl for the next time.

The claim:

1. The natural alternative to wax to remove unwanted hair is made of sugar, water and lemon that suits all kinds of skins and does not cause irritation as wax does. It can be used on any part of the body including sensitive areas like eyebrows.
